(19) United States
(12) Patent Application Publication
(10) Pub. No.: US 2020/0201027 A1
(43) Pub. Date: Jun. 25, 2020

(54) MICROMACHINED MIRROR ASSEMBLY HAVING MULTIPLE COATING LAYERS

(71) Applicant: DiDi Research America, LLC, Mountain View, CA (US)

(72) Inventors: Qin Zhou, Mountain View, CA (US); Youmin Wang, Berkeley, CA (US); Sae Won Lee, Mountain View, CA (US)

(73) Assignee: DiDi Research America, LLC, Mountain View, CA (US)

(21) Appl. No.: 16/228,819

(22) Filed: Dec. 21, 2018

(51) Int. Cl. G02B 26/08; B60R 1/12; G01S 17/93; G01S 7/481

(52) U.S. Cl. CPC G02B 26/0833; B60R 1/12; B60R 2001/1284; G01S 7/4817; G01S 17/936

(57) ABSTRACT

Embodiments of the disclosure provide a micromachined mirror assembly having multiple coating layers. In one example, the micromachined mirror assembly includes a micro mirror having a first thermal expansion coefficient, a reflective layer having a second thermal expansion coefficient, and a compensation layer having a third thermal expansion coefficient. The reflective layer is disposed on a top surface of the micro mirror and is reflective to incident light of the micromachined mirror assembly. The compensation layer is disposed on the reflective layer and is transparent to the incident light of the micromachined mirror assembly. The first thermal expansion coefficient is between the second thermal expansion coefficient and the third thermal expansion coefficient.

### TECHNICAL FIELD

The present disclosure relates to a micromachined mirror assembly, and more particularly to, a micromachined mirror assembly used in a scanner for light detection and ranging (LiDAR).

### BACKGROUND

LiDAR systems have been widely used in autonomous driving and producing high-definition maps. For example, LiDAR systems measure distance to a target by illuminating the target with pulsed laser light and measuring the reflected pulses with a sensor. Differences in laser return times and wavelengths can then be used to make digital three-dimensional (3-D) representations of the target. The laser light used for LiDAR scan may be ultraviolet, visible, or near infrared. Because using a narrow laser beam as the incident light from the scanner can map physical features with very high resolution, a LiDAR system is particularly suitable for applications such as high-definition map surveys.

The scanner of a LiDAR system includes a mirror that can be moved (e.g., rotated) by an actuator to reflect (and steer) incident laser beams from a laser source towards a pre-determined angle. The mirror can be a single, or an array of micromachined mirror assembly(s) made by semiconductor materials using microelectromechanical system (MEMS) technologies. However, since LIDAR systems (including the micromachined mirror assembly) are typically used in an environment in which the temperature variation is significant, the thermal expansion and contraction of the materials forming the micromachined mirror assembly due to the temperature variation can cause the change of curvature of the micromachined mirror assembly, which in turn affects the performance of the LiDAR scanner, e.g., by causing beam divergence.

Embodiments of the disclosure address the above problems by an improved micromachined mirror assembly in a scanner for LiDAR.

### SUMMARY

Embodiments of the disclosure provide a micromachined mirror assembly. The micromachined mirror assembly includes a micro mirror having a first thermal expansion coefficient, a reflective layer having a second thermal expansion coefficient, and a compensation layer having a third thermal expansion coefficient. The reflective layer is disposed on a top surface of the micro mirror and is reflective to incident light of the micromachined mirror assembly. The compensation layer is disposed on the reflective layer and is transparent to the incident light of the micromachined mirror assembly. The first thermal expansion coefficient is between the second thermal expansion coefficient and the third thermal expansion coefficient.

Embodiments of the disclosure also provide another micromachined mirror assembly. The micromachined mirror assembly includes a micro mirror having a first thermal expansion coefficient and at least two coating layers stacked on a top surface of the micro mirror and having a second thermal expansion coefficient and a third thermal expansion coefficient, respectively. The first thermal expansion coefficient is between the second thermal expansion coefficient and the third thermal expansion coefficient.

Embodiments of the disclosure also provide a scanner for LiDAR. The scanner includes a micromachined mirror assembly configured to reflect an incident laser beam and an optical compensation module configured to compensate a beam divergence of the reflected laser beam from the micromachined mirror assembly based on a curvature of the micromachined mirror assembly. The micromachined mirror assembly includes a micro mirror having a first thermal expansion coefficient and at least two coating layers stacked on a top surface of the micro mirror and having a second thermal expansion coefficient and a third thermal expansion coefficient, respectively. The first thermal expansion coefficient is between the second thermal expansion coefficient and the third thermal expansion coefficient.

It is to be understood that both the foregoing general description and the following detailed description are exemplary and explanatory only and are not restrictive of the invention, as claimed.

### BRIEF DESCRIPTION OF THE DRAWINGS

FIG. 1 illustrates a schematic diagram of an exemplary vehicle equipped with a LiDAR system, according to embodiments of the disclosure.

FIG. 2 illustrates a block diagram of an exemplary LiDAR system having a transmitter with a scanner, according to embodiments of the disclosure.

FIGS. 3A-3B illustrate side views of a micromachined mirror assembly in related art.

FIG. 4 illustrates a side view of an exemplary micromachined mirror assembly having multiple coating layers, according to embodiments of the disclosure.

FIG. 5A illustrates a side view of an exemplary micromachined mirror assembly having stacked reflective layer and compensation layer, according to embodiments of the disclosure.

FIG. 5B illustrates a side view of another exemplary micromachined mirror assembly having stacked compensation layer and reflective layer, according to embodiments of the disclosure.

FIG. 6 illustrates an exemplary scanner for LiDAR including a micromachined mirror assembly having multiple coating layers, according to embodiments of the disclosure.

FIG. 7A illustrates a flow chart of an exemplary method for making micromachined mirror assembly having stacked reflective layer and compensation layer, according to embodiments of the disclosure.

FIG. 7B illustrates a flow chart of another exemplary method for making micromachined mirror assembly having stacked reflective layer and compensation layer, according to embodiments of the disclosure.

### DETAILED DESCRIPTION

Reference will now be made in detail to the exemplary embodiments, examples of which are illustrated in the accompanying drawings. Wherever possible, the same reference numbers will be used throughout the drawings to refer to the same or like parts.

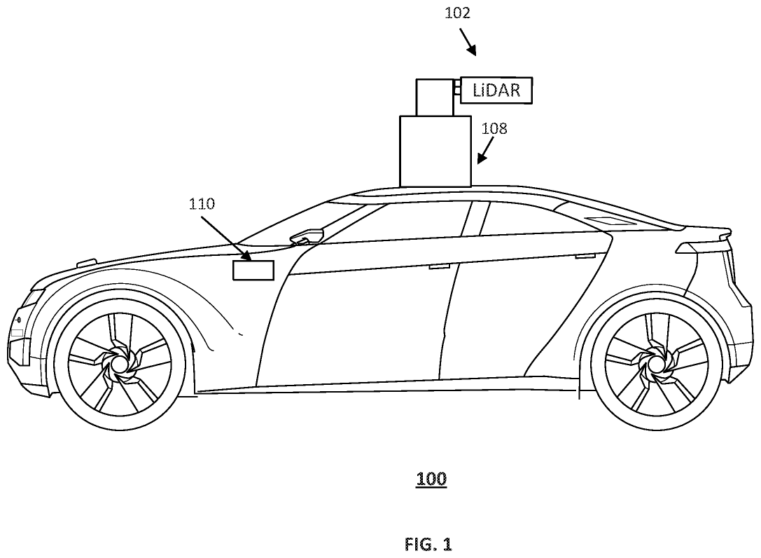

FIG. 1 illustrates a schematic diagram of an exemplary vehicle 100 equipped with a LiDAR system 102, according to embodiments of the disclosure. Consistent with some embodiments, vehicle 100 may be a survey vehicle configured for acquiring data for constructing a high-definition map or 3-D buildings and city modeling.

As illustrated in FIG. 1, vehicle 100 may be equipped with LiDAR system 102 mounted to body 104 via a mounting structure 108. Mounting structure 108 may be an electro-mechanical device installed or otherwise attached to body 104 of vehicle 100. In some embodiments of the present disclosure, mounting structure 108 may use screws, adhesives, or another mounting mechanism. Vehicle 100 may be additionally equipped with a sensor 110 inside or outside body 104 using any suitable mounting mechanisms. Sensor 110 may include sensors used in a navigation unit, such as a Global Positioning System (GPS) receiver and one or more Inertial Measurement Unit (IMU) sensors. It is contemplated that the manners in which LiDAR system 102 or sensor 110 can be equipped on vehicle 100 are not limited by the example shown in FIG. 1 and may be modified depending on the types of LiDAR system 102 and sensor 110 and/or vehicle 100 to achieve desirable 3-D sensing performance.

Consistent with some embodiments, LiDAR system 102 and sensor 110 may be configured to capture data as vehicle 100 moves along a trajectory. For example, a transmitter of LiDAR system 102 is configured to scan the surrounding and acquire point clouds. LiDAR system 102 measures distance to a target by illuminating the target with pulsed laser beam and measuring the reflected pulses with a receiver. The laser beam used for LiDAR system 102 may be ultraviolet, visible, or near infrared. In some embodiments of the present disclosure, LiDAR system 102 may capture point clouds. As vehicle 100 moves along the trajectory, LiDAR system 102 may continuously capture data. Each set of scene data captured at a certain time range is known as a data frame.

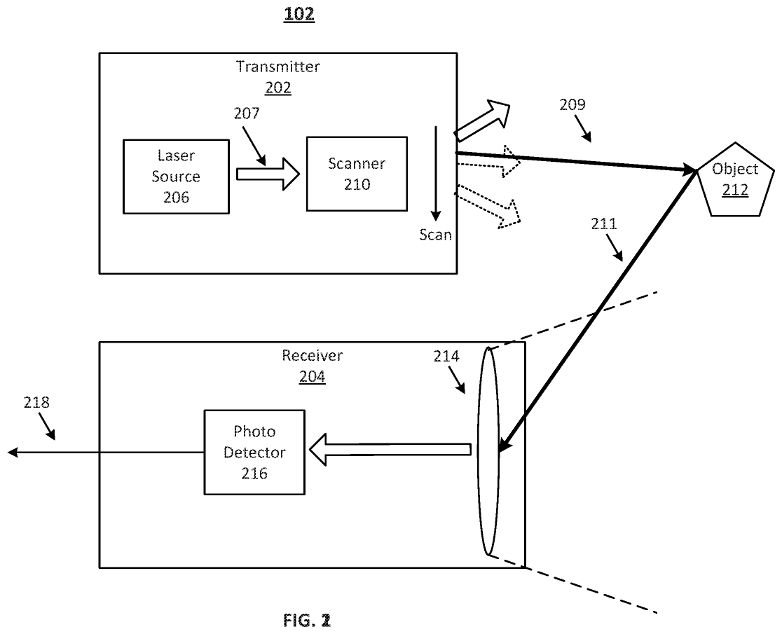

FIG. 2 illustrates a block diagram of an exemplary LiDAR system 102 having a transmitter 202 with a scanner 210, according to embodiments of the disclosure. LiDAR system 102 may include transmitter 202 and a receiver 204. Transmitter 202 may emit laser beams within a scan angle. Transmitter 202 may include one or more laser sources 206 and a scanner 210. As described below in detail, scanner 210 may include a micromachined mirror assembly (not shown) having multiple coating layers to compensate the curvature variation of the micro mirror under different temperatures.

As part of LiDAR system 102, transmitter 202 can sequentially emit a stream of pulsed laser beams in different directions within its scan angle, as illustrated in FIG. 2. Laser source 206 may be configured to provide a laser beam 207 (referred to herein as “native laser beam”) in a respective incident direction to scanner 210. In some embodiments of the present disclosure, laser source 206 may generate a pulsed laser beam in the ultraviolet, visible, or near infrared wavelength range.

In some embodiments of the present disclosure, laser source 206 is a pulsed laser diode (PLD). A PLD may be a semiconductor device similar to a light-emitting diode (LED) in which the laser beam is created at the diode's junction. In some embodiments of the present disclosure, a PLD includes a PIN diode in which the active region is in the intrinsic (I) region, and the carriers (electrons and holes) are pumped into the active region from the N and P regions, respectively. Depending on the semiconductor materials, the wavelength of incident laser beam 207 provided by a PLD may be smaller than 1,100 nm, such as 405 nm, between 445 nm and 465 nm, between 510 nm and 525 nm, 532 nm, 635 nm, between 650 nm and 660 nm, 670 nm, 760 nm, 785 nm, 808 nm, or 848 nm.

Scanner 210 may be configured to emit a laser beam 209 to an object 212 in a first direction. Object 212 may be made of a wide range of materials including, for example, non-metallic objects, rocks, rain, chemical compounds, aerosols, clouds and even single molecules. The wavelength of laser beam 209 emitted may vary based on the composition of object 212. At each time point during the scan, scanner 210 may emit laser beam 209 to object 212 in a direction within the scan angle by rotating the micromachined mirror assembly as the incident angle of incident laser beam 207 may be fixed. In some embodiments of the present disclosure, scanner 210 may also include optical components (e.g., lenses, mirrors) that can focus pulsed laser light into a narrow laser beam to increase the scan resolution and range of object 212.

As part of LiDAR system 102, receiver 204 may be configured to detect a returned laser beam 211 returned from object 212 in a different direction. Receiver 204 can collect laser beams returned from object 212 and output electrical signal reflecting the intensity of the returned laser beams. Upon contact, laser light can be reflected by object 212 via backscattering, such as Rayleigh scattering, Mie scattering, Raman scattering, and fluorescence. As illustrated in FIG. 2, receiver 204 may include a lens 214 and a photodetector 216. Lens 214 be configured to collect light from a respective direction in its field of view (FOV). At each time point during the scan, returned laser beam 211 may be collected by lens 214. Returned laser beam 211 may be returned from object 212 and have the same wavelength as laser beam 209.

Photodetector 216 may be configured to detect returned laser beam 211 returned from object 212. Photodetector 216 may convert the laser light (e.g., returned laser beam 211) collected by lens 214 into an electrical signal 218 (e.g., a current or a voltage signal). The current is generated when photons are absorbed in the photodiode. In some embodiments of the present disclosure, photodetector 216 may include avalanche photodiode (APD), such as a single photon avalanche diode (SPAD), a SPAD array, or a silicon photo multiplier (SiPM).

Although scanner 210 is described as part of transmitter 202, it is understood that in some embodiments, scanner 210 can be part of receiver 204, e.g., before photodetector 216 in the light path. The inclusion of scanner 210 in receiver can ensure photodetector 216 to only capture light, e.g., returned laser beam 211 from desired directions, thereby avoiding the interference from other light sources, such as the sun and/or other LiDAR systems. By increasing the aperture of mirror assembly in scanner 210 in receiver 204, the sensitivity of photodetector 216 can be increased as well.

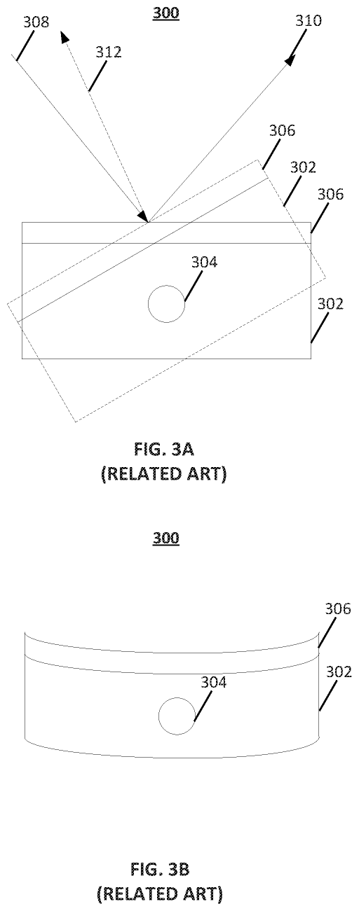

As described above, the incident angle of incident laser beam 207 may be fixed relative to scanner 210, and the scanning of laser beam 209 may be achieved by rotating a single or an array of micromachined mirror assembly in scanner 210. FIGS. 3A and 3B illustrate side views of a micromachined mirror assembly 300 in related art. As shown in FIG. 3A, micromachined mirror assembly 300 include a micro mirror 302 having a hinge 304. Micro mirror 302 may rotate around hinge 304. In some embodiments, micro mirror 302 and hinge 304 are made of semiconductor materials, such as silicon, which may not be reflective to an incident laser beam 308. Thus, micromachine mirror 300 may further include a reflective layer 306 disposed on the top surface (facing incident laser beam 308) of micro mirror 302. Reflective layer 306 may be reflective to incident laser beam 308, which is reflected by micromachined mirror assembly 300 to form a reflected laser beam 310. As shown in FIG. 3A, by rotating micro mirror 302 and reflective layer 306 thereon around hinge 304 (as indicated by dashed lines), incident laser beam 308 may be reflected to a different direction, i.e., to form another reflected laser beam 312.

In some embodiments, reflective layer 306 is made of a metal that is reflective to incident laser beam 308. During the fabrication of reflective layer 306, stress may be built up in reflective layer 306, which can cause the curvature change of micromachined mirror assembly 300, i.e., making reflective layer 306 curved as shown in FIG. 3B. The reflected laser beam from the curved reflective layer 306 may be diverged as well, which is undesirable for controlling the scanning of the laser beams. Moreover, since micro mirror 302 and reflective layer 306 are made of different materials, e.g., semiconductors and metals, which have different thermal expansion coefficients, the curvature change may be further increased as the environmental temperature of micromachined mirror assembly 300 changes. A LiDAR system using micromachined mirror assembly 300 may be used in an environment that has a large temperature variation, such as between −30° C. and 80° C. As a result, the curvature change of micromachined mirror assembly 300 can be very significant when it is used in a LiDAR system.

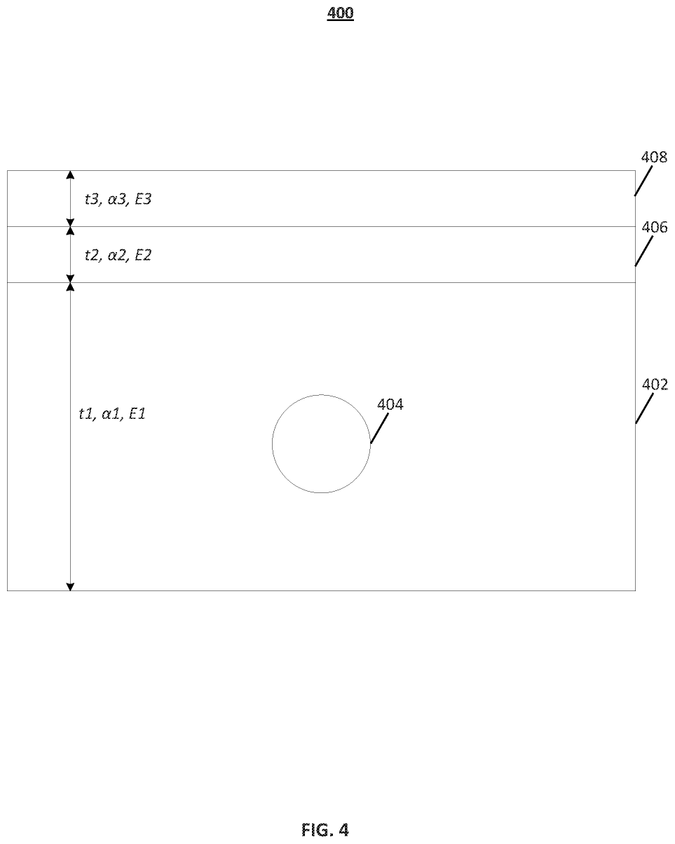

FIG. 4 illustrates a side view of an exemplary micromachined mirror assembly 400 having multiple coating layers, according to embodiments of the disclosure. In addition to a reflective layer, micromachined mirror assembly 400 further includes a compensation layer that can compensate the curvature change at different temperatures due to the mismatch of thermal expansion coefficients between the micro mirror and the reflective layer. As a result, the curvature of micromachined mirror assembly 400 can become thermally-stable, i.e., does not vary at different temperatures.

As shown in FIG. 4, micromachined mirror assembly 400 includes a micro mirror 402 and a hinge 404 on a substrate (not shown). In some embodiments, micro mirror 402 and hinge 404 are made of a semiconductor material, such as silicon. The term “micro mirror” refers to any mirror structure fabricated using microfabrication processes, such as MEMS technologies. Micro mirror 402 may be rotatable around hinge 404 as driven by one or more actuators (not shown) including, but not limited to, electrostatic actuators, electromagnetic actuators, piezoelectric actuators, and thermal actuators. In some embodiments, micromachined mirror assembly 400 include more than one set of hinges and actuators, such as two sets arranged in the orthogonal directions, for rotating micro mirror 402 in multiple dimensions. As a result, the scan angle of the reflected laser beam can be distributed in a 2-D area.

As shown in FIG. 4, two coating layers 406 and 408 are stacked on the top surface of micro mirror 402. The top surface of micro mirror 402 is the main surface toward the incident laser beam and opposite to the substrate (not shown) of micromachined mirror assembly 400. It is understood that in some embodiments, additional layer(s) may be formed between first coating layer 406 and micro mirror 402, such as an adhesion layer for improving the adhesion between first coating layer 406 and micro mirror 402. Similarly, in some embodiments, additional layer(s), such as an adhesion layer, may be formed between first coating layer 406 and second coating layer 408 as well. In some embodiments, the thickness of the additional layer(s), however, may be significantly less than (e.g., less than 1/10 of) the thickness of coating layers 406 and 408 such that the effect of curvature change caused by the additional layer(s) can be ignored. It is understood that in case the thickness of the additional layer(s) is greater than the thickness of coating layers 406 and 408, the thermal expansion of the additional layer(s) may be taken into consideration in determining the suitable thickness of coating layers 406 and/or 408. To compensate the thermally-introduced curvature change, first and second coating layers 406 and 408 may be made of different materials having different thermal expansion coefficients, such as metals and dielectrics. Further, to reflect the laser beams, at least one of first and second coating layers 406 and 408 includes a reflective layer, such as a metal layer, that is reflective to the incident laser beam. Although two coating layers 406 and 408 are illustrated in FIG. 4, it is understood that in some embodiments, more than two coating layers can be stacked on the top surface of micro mirror 402 in which at least one of the coating layers has a thermal expansion coefficient greater than that of micro mirror 402 and at least one of the coating layers has a thermal expansion coefficient smaller than that of micro mirror 402.

In some embodiments, micro mirror 402 has a first thickness t1, a first thermal expansion coefficient α1, and a first Young's modulus E1; first coating layer 406 has a second thickness t2, a second thermal expansion coefficient α2, and a second Young's modulus E2; second coating layer 408 has a third thickness t3, a third thermal expansion coefficient α3, and a third Young's modulus E3. In some embodiments, the first thickness t1 is greater than the second thickness t2 and the third thickness t3. Under such condition, the curvature change of micromachined mirror assembly 400 due to temperature variation can be reduced when the first thermal expansion coefficient α1 is between the second and third thermal expansion coefficients α2 and α3. For example, depending on the values of the second and third thermal expansion coefficients α2 and α3, the first thermal expansion coefficient α1 can be greater than the second thermal expansion coefficient α2 and smaller than the third thermal expansion coefficient α3 (α2<α1<α3) or can be greater than the third thermal expansion coefficient α3 and smaller than the second thermal expansion coefficient (α3<α1<α2), according to some embodiments. In some embodiments, the curvature change of micromachined mirror assembly 400 due to temperature variation can be avoided when the following condition is met:

|α1−α2|=E2=|α1−α3|E3.

That is, a difference between the first and second thermal expansion coefficients α1 and α2 times the second Young's modulus E2 equals to a difference between the first and third thermal expansion coefficients α1 and α3 times the third Young's modulus E3. It is understood that although the above mention condition can be used to avoid the curvature change of micromachined mirror assembly 400 due to temperature variation when the first thickness t1 is greater than the second thickness t2 and the third thickness t3, when the first thickness t1 is not greater than the second thickness t2 or the third thickness t3, the curvature change of micromachined mirror assembly 400 due to temperature variation still may be reduced or even avoided under different conditions.

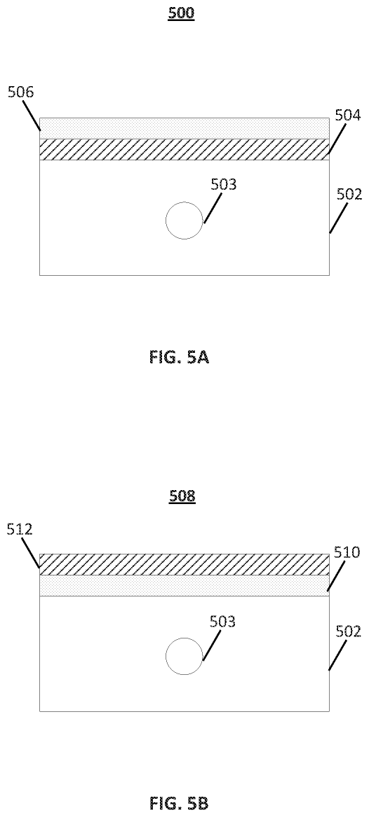

FIG. 5A illustrates a side view of an exemplary micromachined mirror assembly 500 having stacked reflective layer 504 and compensation layer 506, according to embodiments of the disclosure. Micromachined mirror assembly 500 may include a micro mirror 502 and a hinge 503 disposed on a substrate (not shown). In some embodiments, micro mirror 502 is made of a semiconductor material, such as silicon. The thickness of micro mirror 502 may be between 0.1 μm and 1000 μm. Micro mirror 502 may be configured to rotate around hinge 504 within certain angles.

Micromachined mirror assembly 500 may also include a reflective layer 504 disposed on the top surface of micro mirror 502. In some embodiments, the thermal expansion coefficient of reflective layer 504 is greater than the thermal expansion coefficient of micro mirror 502. Reflective layer 504 is reflective to the incident light, such as an incident laser beam, of micromachined mirror assembly 500, according to some embodiments. That is, reflective layer 504 can reflect at least part of the incident light. In some embodiments, reflective layer 504 is made of a metal including, but not limited to, gold, aluminum, platinum, chromium, or silver. In some embodiments, reflective layer 504 is made of one or more dielectrics, such as multiple layers of alternating dielectric layers (also known as Bragg mirror). The thickness of reflective layer 504 may be between 10 nm and 5000 nm. Depending on the adhesion between the materials of micro mirror 502 and reflective layer 504, in some embodiments, a thin adhesion layer, such as a titanium layer, a chromium layer, or a tungsten layer, is formed between micro mirror 502 and reflective layer 504 to improve adhesion therebetween. The thickness of the adhesion layer may be between 0.5 nm and 100 nm.

Micromachined mirror assembly 500 may further include a compensation layer 506 disposed on reflective layer 504. In some embodiments, the thermal expansion coefficient of compensation layer 506 is smaller than the thermal expansion coefficient of micro mirror 502. Compensation layer 506 is transparent to the incident light, such as the incident laser beam, of micromachined mirror assembly 500, according to some embodiments. When compensation layer 506 is transparent to incident light at a wavelength, the incident light at the wavelength can pass through compensation layer 506 covering reflective layer 504 and reflected by reflective layer 504. In some embodiments, compensation layer 506 is made of a dielectric including, but not limited to, silicon oxide. The thickness of compensation layer 506 may be between 1 nm and 5000 nm. Depending on the adhesion between the materials of reflective layer 504 and compensation layer 506, in some embodiments, a thin adhesion layer is formed between reflective layer 504 and compensation layer 506 to improve adhesion therebetween.

In some embodiments, micro mirror 502 is made of silicon having a thermal expansion coefficient of about 3×10⁻⁶/═ C., reflective layer 504 is made of gold having a thermal expansion coefficient of about 16×10⁻⁶/° C., and compensation layer 506 is made of silicon oxide having a thermal expansion coefficient of about 0.5×10⁻⁶/° C.

FIG. 5B illustrates a side view of another exemplary micromachined mirror assembly 508 having stacked compensation layer 510 and reflective layer 512, according to embodiments of the disclosure. Micromachined mirror assembly 508 may include micro mirror 502 and hinge 503 disposed on a substrate (not shown). In some embodiments, micro mirror 502 is made of a semiconductor material, such as silicon. The thickness of micro mirror 502 may be between 0.1 μm and 1000 μm. Micro mirror 502 may be configured to rotate around hinge 503 within certain angles.

Micromachined mirror assembly 508 also further includes a compensation layer 510 disposed on the top surface of micro mirror 502. In some embodiments, the thermal expansion coefficient of compensation layer 510 is smaller than the thermal expansion coefficient of micro mirror 502. Compensation layer 510 is transparent to the incident light, such as the incident laser beam, of micromachined mirror assembly 508, according to some embodiments. In some embodiments, compensation layer 510 is made of a dielectric including, but not limited to, silicon oxide. However, as compensation layer 510 is disposed under a reflective layer 512, compensation layer 510 may not be transparent to the incident light. The thickness of compensation layer 510 may be between 1 nm and 5000 nm. Depending on the adhesion between the materials of compensation layer 510 and micro mirror 502, in some embodiments, a thin adhesion layer is formed between compensation layer 510 and micro mirror 502 to improve adhesion therebetween. The thickness of the adhesion layer may be between 0.5 nm and 100 nm.

Micromachined mirror assembly 508 may further include reflective layer 512 disposed on compensation layer 510. In some embodiments, the thermal expansion coefficient of reflective layer 512 is greater than the thermal expansion coefficient of micro mirror 502. Reflective layer 512 is reflective to the incident light, such as an incident laser beam, of micromachined mirror assembly 508, according to some embodiments. That is, reflective layer 512 can reflect at least part of the incident light. In some embodiments, reflective layer 512 is made of a metal including, but not limited to, gold, aluminum, platinum, chromium, or silver. In some embodiments, reflective layer 512 is made of one or more dielectrics, such as multiple layers of alternating dielectric layers (also known as Bragg mirror). The thickness of reflective layer 512 may be between 10 nm and 5000 nm. Depending on the adhesion between the materials of compensation layer 510 and reflective layer 512, in some embodiments, a thin adhesion layer, such as a titanium layer, a chromium layer, or a tungsten layer, is formed between compensation layer 510 and reflective layer 512 to improve adhesion therebetween.

In some embodiments, micro mirror 502 is made of silicon having a thermal expansion coefficient of about 3×10⁻⁶/° C., compensation layer 510 is made of silicon oxide having a thermal expansion coefficient of about 0.5×10⁻⁶/° C., and reflective layer 512 is made of aluminum having a thermal expansion coefficient of about 24×10⁻⁶/° C.

As described above, coating layers may introduce stress to a micromachined mirror assembly, which can make the micromachined mirror assembly curved. In some embodiments, each of the multiple coating layers (e.g., reflective layers 504 and 512 and compensation layers 506 and 510) may be a stress-free layer at a room temperature to maintain the flatness of the micromachined mirror assembly. For example, the coating parameters (e.g., the deposition temperature, rate, etc.) may be tuned, or a post-deposition thermal treatment (e.g., rapid thermal annealing “RTA”) may be performed, to reduce or even remove the internal stress of a coating layer introduced by the fabrication process.

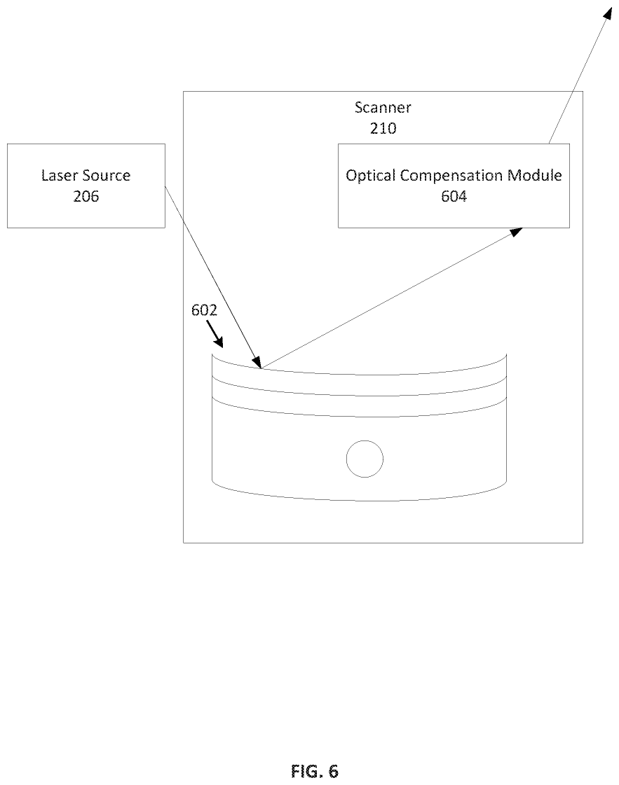

In some embodiments, the micromachined mirror assembly may be curved, and the beam divergency caused by the curved micromachined mirror assembly may be compensated by optical elements. For example, FIG. 6 illustrates exemplary scanner 210 for LiDAR including a micromachined mirror assembly 602 having multiple coating layers, according to embodiments of the disclosure. Scanner 210 may include micromachined mirror assembly 602 having multiple coating layers and an optical compensation module 604. As described above in detail, micromachined mirror assembly 602 may include a micro mirror and at least two coating layers each having a respective thermal expansion coefficient. The thermal expansion coefficient of the micro mirror is between the two thermal expansion coefficients of the at least two coating layers. The details of the micro mirror and the multiple coating layers of micromachined mirror assembly 602 are described above and are not repeated. In some embodiments, since at least one of the multiple coating layers is not a stress-free layer, micromachined mirror assembly 602 may be curved. The arrangement of multiple coating layers with different thermal expansion coefficients, however, can maintain the curvature of micromachined mirror assembly 602 at different temperatures. In other words, the curvature of micromachined mirror assembly 602 is indifferent to the temperature variation.

As a result, optical compensation module 604 may be configured to compensate the beam divergence of the reflected laser beam from micromachined mirror assembly 602 based on the curvature of micromachined mirror assembly 602. Based on the temperature-indifferent curvature of micromachined mirror assembly 602, optical compensation module 604 may include a set of optical elements (e.g., lenses and mirrors) arranged in a way that the beam divergence of the reflected laser beam from micromachined mirror assembly 602 can be compensated or eliminated entirely. In other words, the combination of optical compensation module 604 and curved micromachined mirror assembly 602 functions essentially the same as a flat micromachined mirror assembly with multiple stress-free coating layers described above.

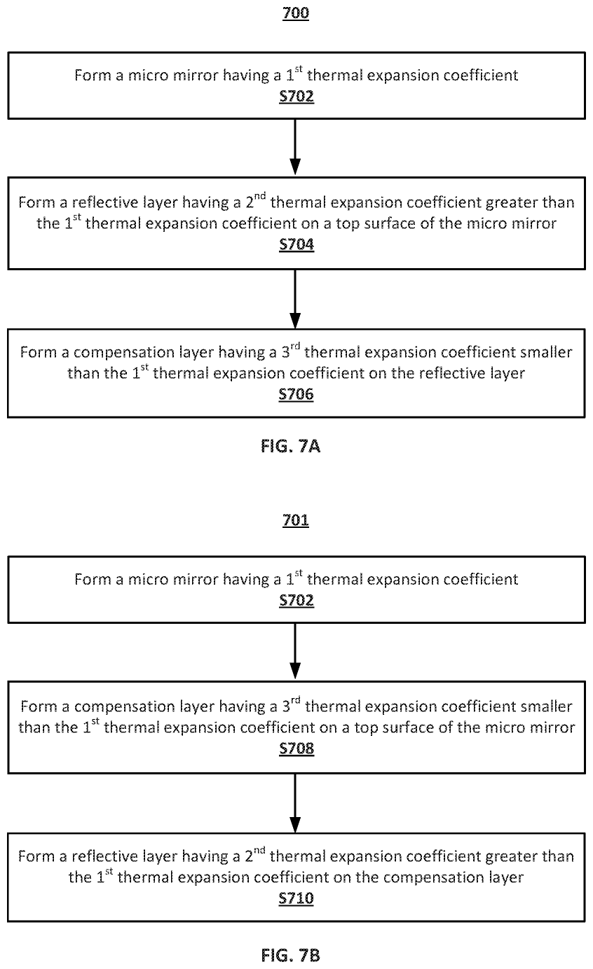

FIG. 7A illustrates a flow chart of an exemplary method 700 for making a micromachined mirror assembly having stacked reflective layer and compensation layer, according to embodiments of the disclosure. For example, method 700 may be used to make micromachined mirror assembly 500 in FIG. 5A. However, method 700 is not limited to that exemplary embodiment. Method 700 may include steps S702-S706 as described below. It is to be appreciated that some of the steps may be optional to perform the disclosure provided herein. Further, some of the steps may be performed simultaneously, or in a different order than shown in FIG. 7A.

In step S702, a micro mirror having a first thermal expansion coefficient may be formed. The micro mirror may be made of silicon. In some embodiments, one or more microfabrication processes used by MEMS technologies are used for forming the micro mirror including, but not limited to, photolithography, development, dry etching, wet etching, lift-off, deposition, chemical mechanical polishing (CMP), ion implantation, etc.

In step S704, a reflective layer having a second thermal expansion coefficient greater than the first thermal expansion coefficient may be formed on the top surface of the micro mirror. In some embodiments, an adhesion layer, such as a titanium layer or a tantalum layer, may be formed first on the top surface of the micro mirror using one or more deposition processes, such as chemical vapor deposition (CVD), physical vapor deposition (PVD), atomic layer deposition (ALD), spin-coating, spray-coating, any other suitable process, or any combination thereof. In some embodiments, the reflective layer is made of a metal, such as gold or aluminum. The reflective layer may be formed directly on the top surface of the micro mirror or on the adhesion layer using one or more deposition processes, such as CVD, PVD, ALD, electroplating, electrodeless plating, spin-coating, spray-coating, any other suitable process, or any combination thereof. In some embodiments, the deposition parameters, such as the temperature and rate, can be controlled to adjust or even remove the stress of the reflective layer. The thickness of the reflective layer can be controlled by the deposition parameters, such as the temperature, duration, rate, and cycles as well.

In step S706, a compensation layer having a third thermal expansion coefficient smaller than the first thermal expansion coefficient may be formed on the reflective layer. In some embodiments, an adhesion layer, such as a titanium layer or a tantalum layer, may be formed first on the reflective layer using one or more deposition processes, such as CVD, PVD, ALD, spin-coating, spray-coating, any other suitable process, or any combination thereof. In some embodiments, the compensation layer is made of a dielectric, such as silicon oxide. The compensation layer may be formed directly on the top surface of the reflective layer or on the adhesion layer using one or more deposition processes, such as CVD, PVD, ALD, electroplating, electrodeless plating, spin-coating, spray-coating, any other suitable process, or any combination thereof. In some embodiments, the deposition parameters, such as the temperature and rate, can be controlled to adjust or even remove the stress of the compensation layer. The thickness of the compensation layer can be controlled by the deposition parameters, such as the temperature, duration, rate, and cycles as well.

FIG. 7B illustrates a flow chart of another exemplary method 701 for making micromachined mirror assembly having stacked reflective layer and compensation layer, according to embodiments of the disclosure. For example, method 701 may be used to make micromachined mirror assembly 508 in FIG. 5B. However, method 701 is not limited to that exemplary embodiment. Method 701 may include steps S702, S708, and S710 as described below. It is to be appreciated that some of the steps may be optional to perform the disclosure provided herein. Further, some of the steps may be performed simultaneously, or in a different order than shown in FIG. 7B.

Step S702 of method 701 is the same as step S702 of method 700 and the description of the step is not repeated.

In step S708, a compensation layer having a third thermal expansion coefficient smaller than the first thermal expansion coefficient may be formed on the top surface of the micro mirror. In some embodiments, an adhesion layer, such as a titanium layer or a tantalum layer, may be formed first on the top surface of the micro mirror using one or more deposition processes, such as CVD, PVD, ALD, spin-coating, spray-coating, any other suitable process, or any combination thereof. In some embodiments, the compensation layer is made of a dielectric, such as silicon oxide. The compensation layer may be formed directly on the top surface of the micro mirror or on the adhesion layer using one or more deposition processes, such as CVD, PVD, ALD, electroplating, electrodeless plating, spin-coating, spray-coating, any other suitable process, or any combination thereof. In some embodiments, the deposition parameters, such as the temperature and rate, can be controlled to adjust or even remove the stress of the compensation layer. The thickness of the compensation layer can be controlled by the deposition parameters, such as the temperature, duration, rate, and cycles as well.

In step S710, a reflective layer having a second thermal expansion coefficient greater than the first thermal expansion coefficient may be formed on the compensation layer. In some embodiments, an adhesion layer, such as a titanium layer or a tantalum layer, may be formed first on the compensation layer using one or more deposition processes, such as CVD, PVD, ALD, spin-coating, spray-coating, any other suitable process, or any combination thereof. In some embodiments, the reflective layer is made of a metal, such as gold or aluminum. The reflective layer may be formed directly on the top surface of the compensation layer or on the adhesion layer using one or more deposition processes, such as CVD, PVD, ALD, electroplating, electrodeless plating, spin-coating, spray-coating, any other suitable process, or any combination thereof. In some embodiments, the deposition parameters, such as the temperature and rate, can be controlled to adjust or even remove the stress of the reflective layer. The thickness of the reflective layer can be controlled by the deposition parameters, such as the temperature, duration, rate, and cycles as well.

It will be apparent to those skilled in the art that various modifications and variations can be made to the disclosed system and related methods. Other embodiments will be apparent to those skilled in the art from consideration of the specification and practice of the disclosed system and related methods.

It is intended that the specification and examples be considered as exemplary only, with a true scope being indicated by the following claims and their equivalents.

What is claimed is:

1. A micromachined mirror assembly, comprising:
a micro mirror having a first thermal expansion coefficient;
a reflective layer having a second thermal expansion coefficient disposed on a top surface of the micro mirror, the reflective layer being reflective to incident light of the micromachined mirror assembly; and
a compensation layer having a third thermal expansion coefficient disposed on the reflective layer, the compensation layer being transparent to the incident light of the micromachined mirror assembly,
wherein the first thermal expansion coefficient is between the second thermal expansion coefficient and the third thermal expansion coefficient.

2. The micromachined mirror assembly of claim 1, wherein the micro mirror is made of silicon.

3. The micromachined mirror assembly of claim 1, wherein the reflective layer is made of a metal, and the compensation layer is made of a dielectric.

4. The micromachined mirror assembly of claim 3, wherein the metal comprises gold or aluminum, and the dielectric comprises silicon oxide.

5. The micromachined mirror assembly of claim 1, wherein the reflective layer comprises a plurality of alternating dielectric layers.

6. The micromachined mirror assembly of claim 1, wherein the first thermal expansion coefficient is smaller than the second thermal expansion coefficient, and the first thermal expansion coefficient is greater than the third thermal expansion coefficient.

7. The micromachined mirror assembly of claim 6, wherein a difference between the first and second thermal expansion coefficients times a Young's modulus of the reflective layer substantially equals a difference between the first and third thermal expansion coefficients times a Young's modulus of the compensation layer.

8. The micromachined mirror assembly of claim 1, wherein each of the reflective layer and the compensation layer is a stress-free layer at a room temperature.

9. A micromachined mirror assembly, comprising:
a micro mirror having a first thermal expansion coefficient; and
at least two coating layers stacked on a top surface of the micro mirror and having a second thermal expansion coefficient and a third thermal expansion coefficient, respectively;
wherein the first thermal expansion coefficient is between the second thermal expansion coefficient and the third thermal expansion coefficient.

10. The micromachined mirror assembly of claim 9, wherein the micro mirror is made of silicon.

11. The micromachined mirror assembly of claim 9, wherein the at least two coating layers comprise a reflective layer reflective to incident light of the micromachined mirror assembly and a compensation layer transparent to the incident light of the micromachined mirror assembly.

12. The micromachined mirror assembly of claim 11, wherein the reflective layer is made of a metal, and the compensation layer is made of a dielectric.

13. The micromachined mirror assembly of claim 12, wherein the metal comprises gold or aluminum, and the dielectric comprises silicon oxide.

14. The micromachined mirror assembly of claim 11, wherein the reflective layer comprises a plurality of alternating dielectric layers.

15. The micromachined mirror assembly of claim 1, wherein the first thermal expansion coefficient is smaller than the second thermal expansion coefficient, and the first thermal expansion coefficient is greater than the third thermal expansion coefficient.

16. The micromachined mirror assembly of claim 15, wherein a difference between the first and second thermal expansion coefficients times a Young's modulus of the reflective layer substantially equals a difference between the first and third thermal expansion coefficients times a Young's modulus of the compensation layer.

17. The micromachined mirror assembly of claim 11, wherein each of the at least two coating layers is a stress-free layer at a room temperature.

18. A scanner for light detection and ranging (LiDAR), comprising:
a micromachined mirror assembly configured to reflect an incident laser beam and comprising:
a micro mirror having a first thermal expansion coefficient; and
at least two coating layers stacked on a top surface of the micro mirror and having a second thermal expansion coefficient and a third thermal expansion coefficient, respectively;
wherein the first thermal expansion coefficient is between the second thermal expansion coefficient and the third thermal expansion coefficient; and
an optical compensation module configured to compensate a beam divergence of the reflected layer beam from the micromachined mirror assembly based on a curvature of the micromachined mirror assembly.

19. The scanner of claim 18, wherein the micro mirror is made of silicon.

20. The scanner of claim 18, wherein the at least two coating layers comprise a reflective layer reflective to the incident laser beam and a compensation layer transparent to the incident laser beam.
